(19) United States
(12) Patent Application Publication
(10) Pub. No.: US 2013/0035794 A1
(43) Pub. Date: Feb. 7, 2013

(54) METHOD AND SYSTEM FOR CONTROLLING BUILDING ENERGY USE

(71) Applicant: Behzad IMANI, San Mateo, CA (US)

(72) Inventor: Behzad IMANI, San Mateo, CA (US)

(21) Appl. No.: 13/197,680

(22) Filed: Aug. 3, 2011

(51) Int. Cl. G05D 23/00; G06F 17/50

(52) U.S. Cl. 700/276; 703/1

(57) ABSTRACT

In the field of building energy efficiency, an analysis and control system is provided to design, retrofit and/or manage operation of the HVAC and/or hot water systems in a building, so as to minimize energy usage. The present system is an end-to-end computer software based approach for full time commissioning of mechanical systems in a building. It uses standard and advanced fluid dynamics modeling techniques in terms of air circulation, refrigerating, heating and hot water systems.

### FIELD OF THE INVENTION

This invention relates to energy conservation for buildings. U.S. patent application Ser. No. 12/888,277, filed Sep. 22, 2010, inventor Behzad Imani, is incorporated herein by reference in its entirety.

### BACKGROUND OF THE INVENTION

Existing buildings suffer from simultaneous cooling and heating, inefficient cooling, dead zones, simultaneous over cooling or under cooling in the system and in different zones, and uncontrolled and rapid deterioration of mechanical system components. Commercial buildings do not operate at their optimum energy state. Even if they do, buildings “drift” within 3 years from their optimum energy operations state. Moreover, even if operating in an optimum energy state, one or more or all of the HVAC components drift over time such that the faulty component will result in malfunction of the rest of the system. Thereby energy efficiency decreases substantially. FIG. 1 illustrates (upper curve) conceptual efficiency of a normal building's energy profile which is temperature (horizontal axis) vs. energy cost (vertical axis) with respect to combined efficiency of its components.

In the past 40 years, energy prices have elevated at an annual rate of about 7% per year in California. It has been found that 99% of installed HVAC systems in commercial building are operating sub-optimally. HVAC accounts for 55% of energy bills in a typical commercial building. HVAC optimization has the fastest pay back compared to other energy Efficiency retrofits.

There are five known efficiencies in a retrofitted building:
Component Efficiencies (High R value windows and envelopes, LED lighting)
Source Efficiencies (solar electric panels and solar hot water, wind turbines)
Storage Efficiencies (Lithium batteries, Ice Storage)
HVAC Efficiencies (Also known as Distribution Efficiencies: Boiler, Compressor, and Air Delivery Systems)
Control and Monitoring Efficiencies

### SUMMARY

The present system in one embodiment includes an end-to-end software process with in depth monitoring and control solutions for commissioning of mechanical systems in large buildings such as commercial buildings. The present system “tunes up” (optimizes operation of) the HVAC (heating, ventilation, air conditioning) and/or hot water supply systems a building, aligns the components of the HVAC systems, then it applies in one embodiment remote wireless software as a service-based control to maintain the building systems at their optimum energy state. The present system also controls and monitors other energy systems within the building such as lighting, water usage, energy storage, and other renewable sources. The present system typical savings in cost of energy (electricity, gas, etc.) used for HVAC purposes over conventional systems is, e.g., 40% per year in commercial buildings. The key to success of the present system is efficiency by design and efficiency by monitoring and control. The present system uses standard and advanced fluid dynamic and advanced thermo-dynamic methods such as Multi Phase CFD, Compressible flow CFDs, and Refrigerants Flow Dynamics techniques for Energy Efficiency Building Information Modeling (EEBIM). The present system utilizes a new form of comprehensive Building Information Modeling, EEBIM where EE stands for Energy Efficiency, for dynamic energy modeling of building from an energy efficiency point of view. EEBIM is a linear and optimization model for the general energy flow equation linearized around an operating temperature range of, e.g., 69 to 73 degrees. Linearization means removal or reducing the effects of non-linear components such as dampers, and placement of bounds on their non linear behavior. The EEBIM s together with the placements of sensors in critical positions will enable the present system to better control the entire buildings including its mechanical and HVAC components, air cooling and or hot water system. The present system applies a matrix as explained below for precise control and full time commissioning of the entire HVAC system that includes the mechanical system, refrigeration flow, air delivery system and zone control.

The present system has detailed thermodynamic and fluid mechanic analysis and design plus approach as well as tight monitoring and control of the mechanical components within the building. Therefore the present system not only reduces the energy consumption curve of the building, but also makes daily operation of the building less problematic, and will increase the life expectancy of the components. Since the present system is e.g. wireless and may reside in a “cloud” computing environment, it can analyze the large volume of trend data in the buildings and compare them with ideal models. Thus control and monitoring of the system and its components will be easier because the present system monitor and control reach out to the components that are interdependent and otherwise hard to monitor. Yet, these independent components interact with each other and make the system highly interdependent. The fact is that the operation of mechanical systems and their interaction with the building is a very convoluted operation. The present system controls the component behavior in a synchronized fashion with respect to the entire system performance, such that the energy usage is kept at its most optimum level and the life expectancy of the system is increased. The present system is not restricted to optimization, monitor and control of HVAC systems. The present system optimization, monitor and control can be applied to any system and project that involves heat transfer in a medium. For example, the present system could be applied to energy storage devices or batteries that utilize compressed air as storage medium. Such batteries can be used in commercial buildings as storage components. The present system can also be applied to refineries, data centers and other high energy demand systems.

The present system optimizations, monitor, and control can be applied to HVAC systems, complex mechanical systems such as boilers, hot water generations, chillers, space cooling and space heating systems, geothermal systems, chill beams, radiant panels as well as solar hot water, solar co generations, and water treatments in commercial buildings. Moreover, the present system can be applied to massive cooling and heating systems in district cooling and district heating for down towns and joint commercial and apartment campuses.

The present system is ideal for high load infrastructures such as refineries, mass bio fuel systems, and mass bio fuels systems, and any other any conversion system. A goal of the present system is to analyze and model the heat flow characteristics within the systems with thermodynamic, fluid mechanics, and CFDs, comprehensible fluid and multi phased CFDs, establish the trend data at the critical junctions within the system, and then control the entire system. The present system is replacing the old enthalpy charts with detailed analytical techniques.

The present system is in the field of diagnostic, design, retrofit, control and optimization of HVAC systems for new and retrofit buildings. The present system produces energy savings in commercial buildings via auto commissioning, retro commissioning, and open commissioning of HVAC system using state of the art fluid dynamic techniques. An advantage of the present system is in detailed analysis of the HVAC system and establishing the critical trend data for observing and monitoring the HVAC system performance.

### BRIEF DESCRIPTION OF THE FIGURES

FIG. 1 shows a graph of relative energy efficiencies.

FIG. 2A shows the present system.

FIG. 2B shows structure of the present building control system.

FIG. 2C shows detail of FIG. 2B.

FIG. 2D shows the software as part of FIG. 2C.

FIG. 2E shows detail of FIG. 2D.

FIGS. 3a, 3b, 3c and 3d show trend line plots.

FIG. 4 shows a conventional HVAC system.

FIG. 5 shows conventional problems with cooling system.

FIG. 6 shows a conventional VAV box.

FIGS. 7a, 7b show simulations of VAV boxes.

### DETAILED DESCRIPTION

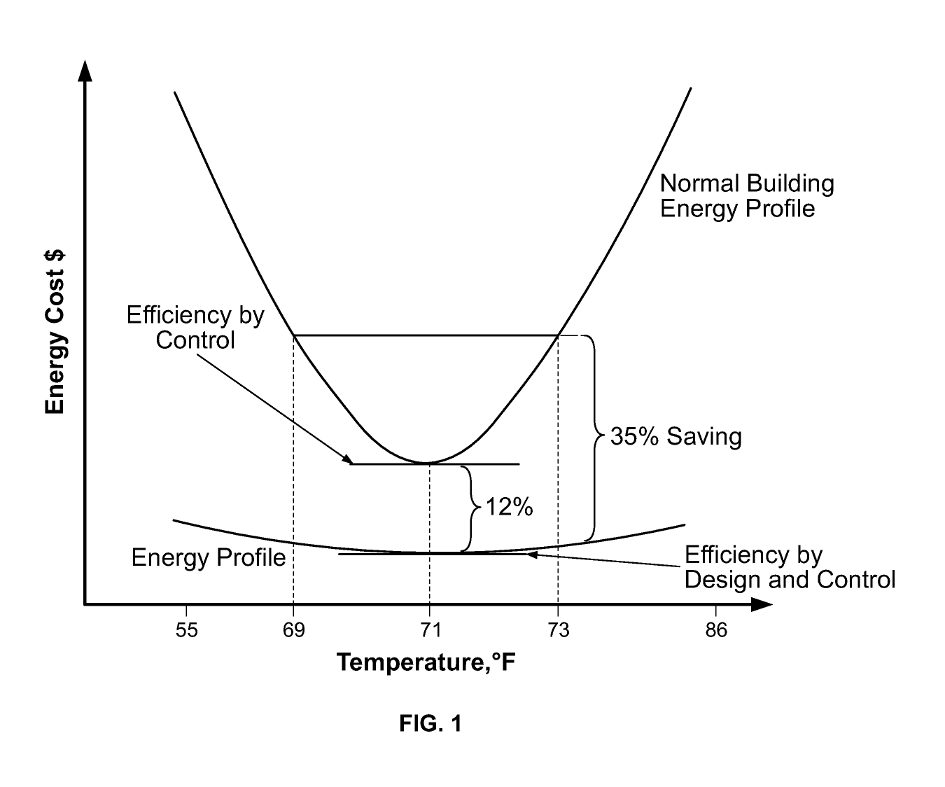

The present system deals with the above mentioned HVAC efficiencies, control and monitoring efficiencies because they generally have the fastest payback time (e.g., less than 3 years) in a retrofitted building. Relative efficiencies achievable with the present system are shown in FIG. 1 at the intermediate and lower curves. The present system provides HVAC optimization, monitoring and control application incorporating software similar to that offered commercially by Silver Springs Network, where the Silver Springs Network software is the “back end”, and the present system is the “front end with” applications on e.g. large buildings. The present system can be installed together with either commercially available Echelon (power line communication medium) or Silver Springs type software. The present system offers full time auto commissioning. The wireless (radio local area network) medium is that offered by e.g. Silver Springs Network, Echelon, their competitors or the Smart Grid Interoperability Pane (SGIP) universal transcoder.

### Inputs to the Present System

These include:
(1) A conventional AutoCAD architectural floor plan, the building address (e.g., from Google maps), a site visit inspection reports for design, optimization and retrofit of HVAC systems. The present system models the EEBIM (energy efficiency building information modeling) of the building using thermodynamic and fluid dynamic techniques and establishes the critical trend data. The present system tunes up (optimizes) the HVAC system and the building performance while establishing the critical trend data for observation and monitoring of the building.
(2) Trending. The present system utilizes critical sensor read outs for full time monitoring, control and commissioning of HVAC system. The present system keeps the building at or near the optimum energy usage,
(3) On demand and periodic “critical measurements”, and comparing them with fluid dynamic models.
(4) The present system creates performance reports, repair and maintenance schedules over time by observing the drift behavior of building mechanical parts.

The present system output includes retrofit, design, implementation, control and maintenance of an HVAC system, operating at the most optimum energy consumption and most comfortable condition. The present system produces maintenance schedules, operational alarms, and equipment tune up schedules. The present system uses a SaaS (software as a service) based EEBIM, monitoring and control software solution include: audit using the AutoCAD design and address of the building as input files to the present system; and bench marking prior to retrofit optimization. So the present system provider efficiency by design, retrofit, testing, commissioning, bench marking post retrofit optimization, sensor placements and calibrations, sensing, trending, and data stream monitoring, critical system alarm flags (when a component malfunctions), and efficiency by monitoring, control, and full time auto commissioning.

### Benchmarking

Many existing software packages establish the bench marking of a building based on the use (office, hospital, data center), occupancy, and the computers, hardware in the server rooms while talking to account the construction date of the building. The present system interfaces with such existing software.

The present system controls the actuators, damper positions, flow velocity, input powers to the individual components and fans, pressures, induction and suction pressures, mass rates, and all other controllable components within the system. The controllable components vary from system to system. Typically there are 3 to 4 layers of control between the present system and the individual components. The details of control functions and commands depend on the system under observation. But generally, dampers, actuators, temperature and pressure, input power, mass flow rate, input and indoor flow rates, refrigerant velocity, air pressure and velocity inside the duct system, and other such parameters constitute the control parameters.

### System Components and Architecture

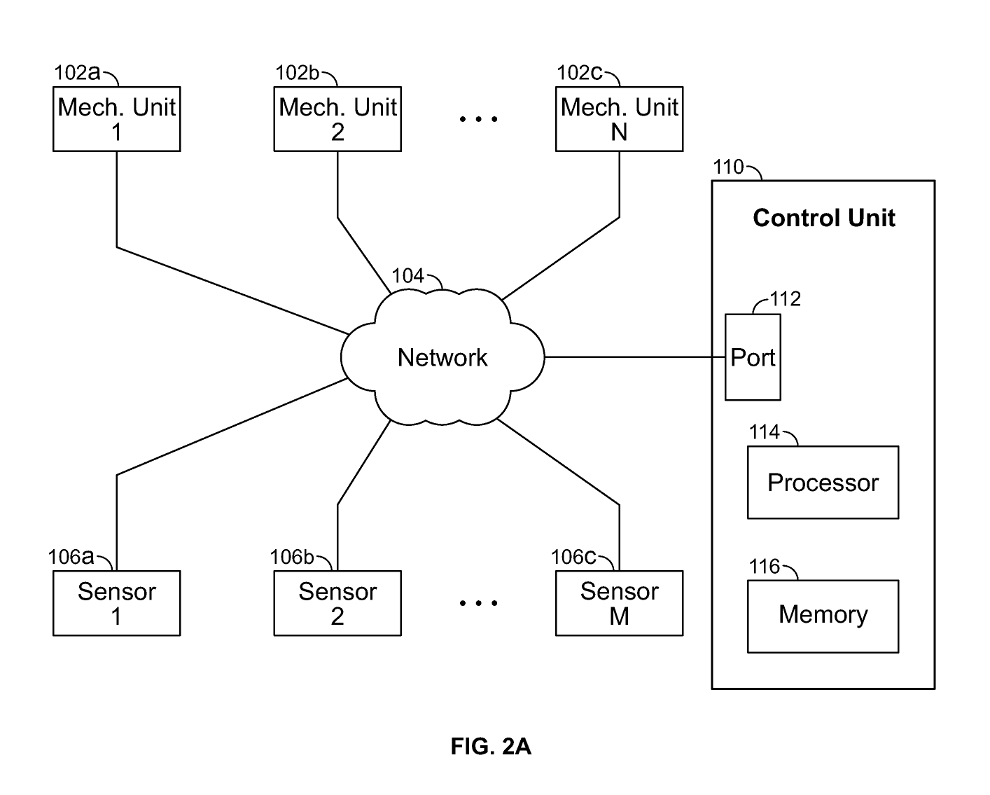

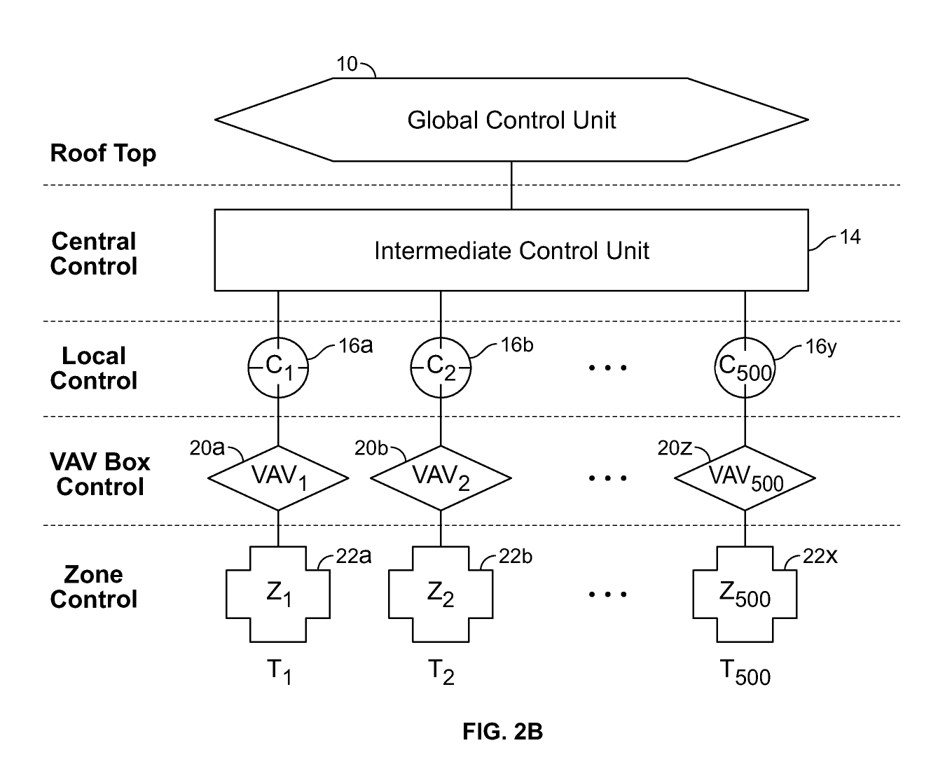

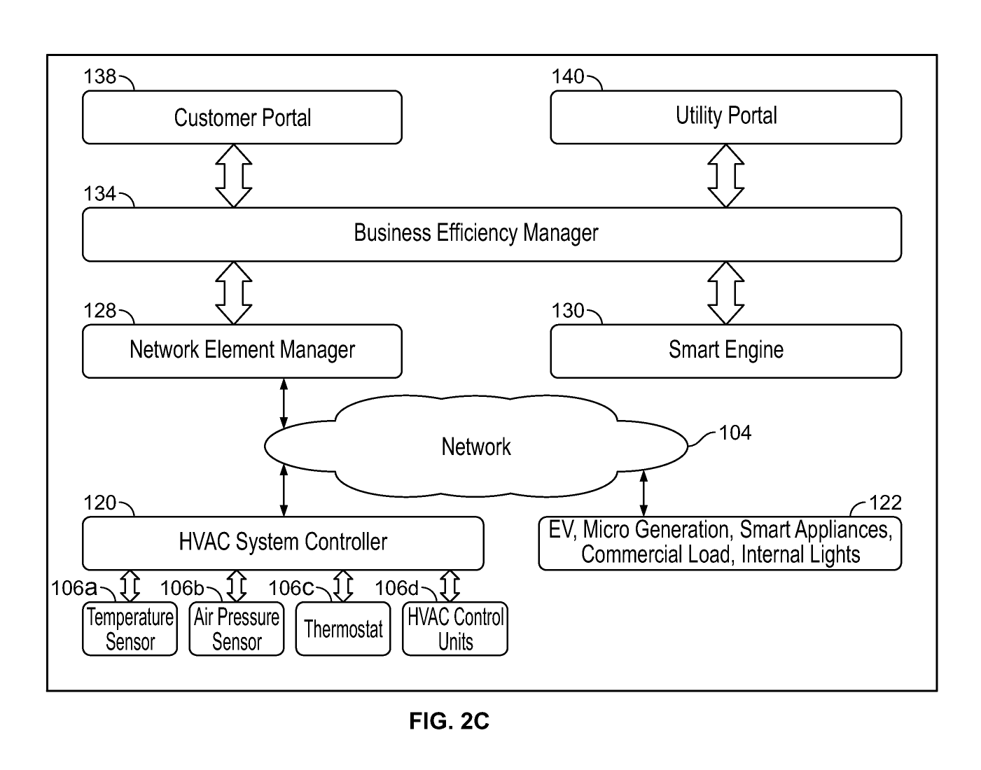

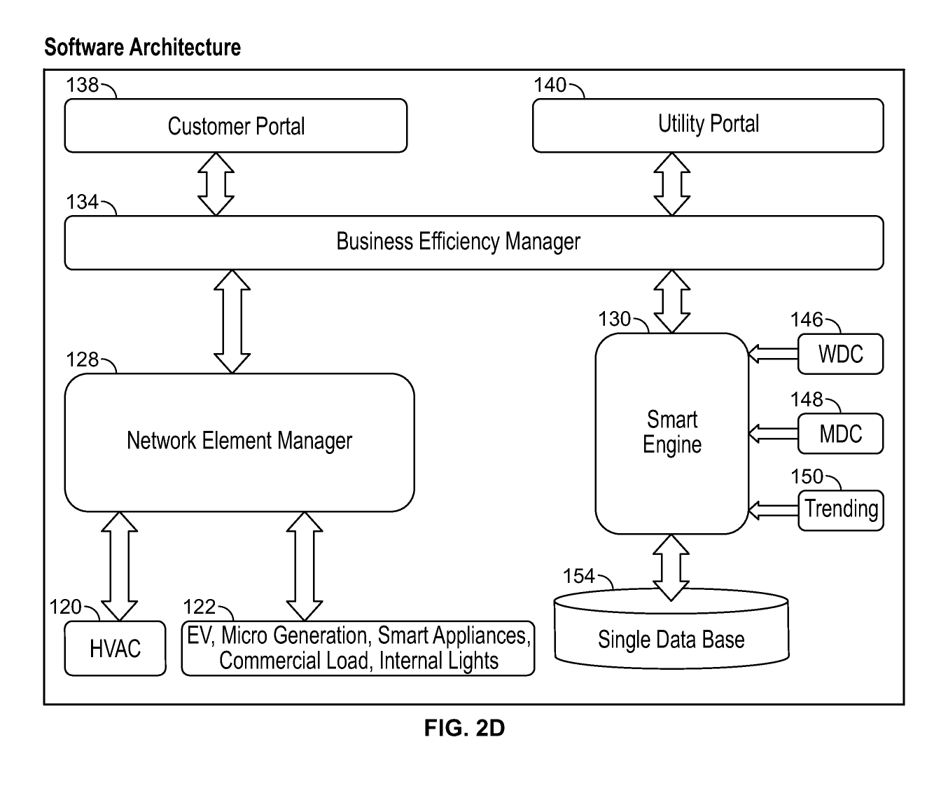

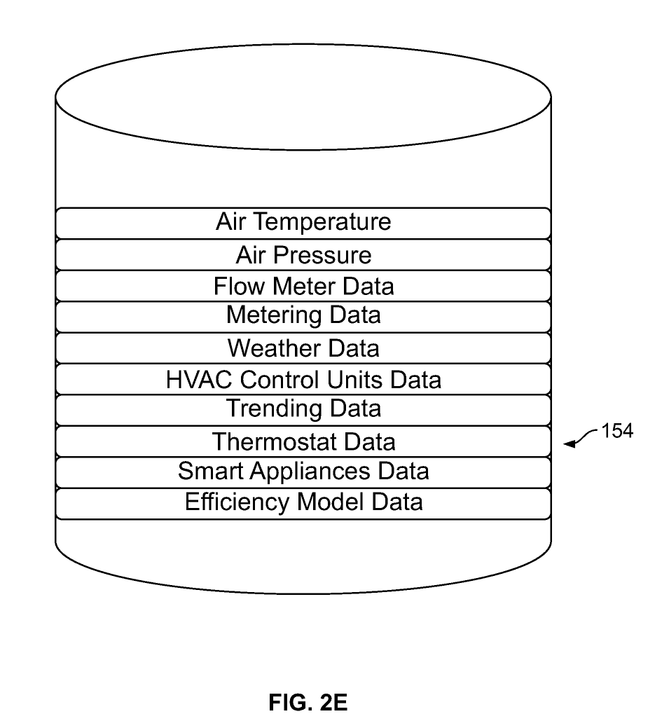

FIG. 2A shows a building system in terms of conventional components to which the present invention is applicable. The system includes conventionally a set of mechanical units 102a, 102b, 102c of which they are indicated as being an integer number N where N depends on the complexity of the building. These are each coupled to a network 104 which is of the type described here such as wired or wireless or power line network. In turn, network 104 is coupled to a set of sensors 106a, 106b, 106c, etc., which there a number M where M is typically much larger than N. In turn the network 104 is coupled via conventional port 112 to a control unit 110 which includes conventionally a processor 114 and memory 116. All these elements individually are largely conventional, except for what occurs in the control unit.

FIG. 2B shows (in terms of building location) and identifies software components of the present system monitoring and control software, including a global (system wide) global control unit 10, an intermediate control unit 14, local control units 16a etc., VAV (variable air volume) box controls 20a, etc., and zone control units 22a, etc. as would be used in the system of FIG. 2A.

FIG. 2C shows the system of FIG. 2A in greater detail including aspects in accordance with the present invention. Elements the same as in the previous figures have the same reference number. In this case, along the bottom are shown the various sensor units, each of a particular type such as temperature, air pressure, a thermostat, or the HVAC control units. These in turn are all coupled to an HVAC system in controller 120 which would include, for instance, elements shown in FIG. 2B. This is coupled to the network 104 which is also coupled other building systems which use energy such as EV [What is EV?], micro electricity or heat generation, smart appliances, commercial load measurements and internal lights which provide data to the network 104. At the level of the control system above the network 104 in FIG. 2C, there is a network element manager 128 which is coupled to a business efficiency manager 134. These are software components. These are driven by a so-called smart engine 130 which is another software component for managing the system. Also provided are interfaces or portals, one for the customer 138 which would be the building owner and the other for the utility 140 which would be the supplier of gas and electricity.

FIG. 2D shows elements similar to those of FIG. 2C, but also showing how the smart engine 130 has its own dedicated database 156 and components weather data collector (WDC) 146, meter data collector (MDC) 148 and a trending component 150, all of which are software elements. In detail, the type of data stored in the database 154 is shown in FIG. 2E.

### Trending

Trending refers here to active sensing. Here more specifically, trending refers to observing behavior of the HVAC system and its interaction with the building to see how well the entire system is performing. The most important raw data are: temperature, carbon dioxide levels, air velocity in three directions, pressure in three direction, temperature drop, pressure drop, velocity, humidity, buoyancy, and air flow rate, mass flow rate, refrigerant flow rate, physical state of the refrigeration/heating medium in the system, and hydraulic torque. There are derivative trend points such as enthalpy, entropy, compression ratio, coefficient of performance and other thermodynamic values, output vs. input power in conventional VAV (variable air volume) boxes. The present system first establishes the trend points and then actively monitors their behavior over time. The present system is directed to the flow parameters such as velocity, pressure, buoyancy that are the output of the VAV boxes vs. input power. Similarly, the present system is directed to the placement of carbon dioxide monitors in return ducts for air quality measurements and for optimum filtrations and over all system occupancy loads.

The present system addresses in some embodiments: efficiency by design and efficiency by monitoring and control, and full time auto commissioning (continuous tune up of the system).

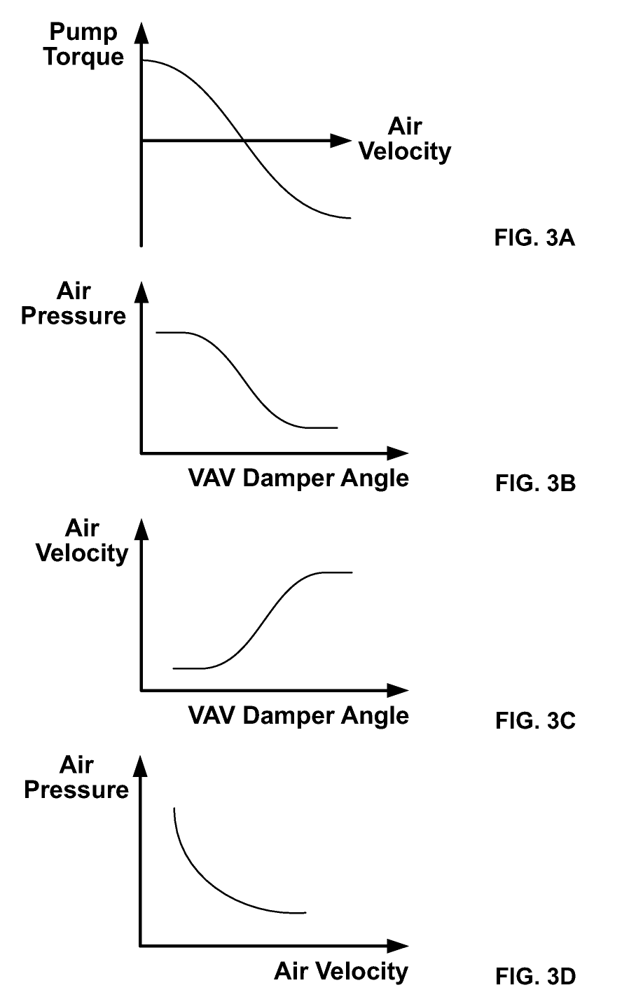

The system generates trend lines (plots) for e.g. a typical center fusion pump system and transmission valves in an HVAC system, the trend lines being determined using CFD techniques, see FIGS. 3a, 3b, 3c, and 3d. Also available are simulation of the trend lines for temperature and velocity and pressure inside the duct system, as well as rooms of a building with complicated mechanical systems which have radiant panels and chilled beams connected to a geothermal system.

### System Trending

By placing numerous pressure, temperature, velocity, mass flow rate, buoyancy, pressure drop, temperature gradient, humidity, enthalpy, linear and non linear transducers such as linear voltage differential transducers (LVDT), energy transducers, and other flow based sensors in the HVAC system, one monitors the performance of the system including the HVAC components, HVAC delivery systems including the VAV boxes and zone temperature. The system trend lines are based on flow parameters. The system trend lines are not necessarily a function of time. They may be a function of velocity magnitude, where time is an implicit variable. Note that in mechanical systems in general , and in VAV boxes in particular, the damper size affects the linearity of air flow. This is peculiar because it affects the critical position and placements of sensors for accurate monitoring of the flow trend data. The present system can establish flow based trend data that includes the non linear effects of component on the flow. The present system trend data are flow based variables, not necessarily electrical based. So the present system detail analysis allows for the static pressure drops to be resolved and reduced by 2 to 100 fold. For example, in a VAV box, if the pressure drop was at 0.1 inch of water, the present system reduces it to 0.03 inch of water, but accurately adjusting for the damper position for maximum flow with respect to the rest of the system. In centrifugal pumps, the hydraulic torque vs. velocity and the head diameter vs. flow velocity magnitude provide good trend lines. In valves, the velocity magnitude vs. inlet pressure provides good trend lines. The conclusion here is that the trend lines are not necessary a function of time. Trends could be a function of each other or a derivative of time.

Furthermore, since the present system analyzes and establishes critical trend data, one can place the sensors in exact positions where the flow is laminar. For instance, the present system places the pressure sensors inside the duct system at the most optimum laminar position instead of placing it at an arbitrarily selected location of ⅓ distance to the load.

The present system trend lines includes trend lines (see FIGS. 3a to 3d) for monitoring the fluid dynamic and thermodynamic parameters within and in between mechanical system components, air delivery system, and zones and rooms at critical places. The flow based trend parameters are either a function of time or a function of each other or a time dependent variable like velocity. For example, temperature, pressure, velocity, torque, humidity, buoyancy, mass transfer Rate, enthalpy, entropy, thermal radiation/convection/conduction, gradients, flow profile, flow uniformity, laminar flow, and other thermodynamic and fluid mechanic terms are flow parameters that could be directly or indirectly monitored and observed. So these are the primary constituents of the trend lines as a function of time, however, one might establish combined trend lines when these parameters are functions of one another or velocity or some other combined functions. For example, a trend line may be established by the uniformity of flow vs. the damper positional angle in a VAV box.

### Components for Measurements and Observations of Trends

The present system introduces piezo-electric, electro optic, acousto optic and, magneto optic or simple electro chemical and transducer components for measurements of the trend data. This may be a simple instrument for pressure measurements using either LVDTs and/or an optical light for accurate measurements of the pressure in a flow. All sensors are subject to frequent and periodic calibration by comparing their outputs to that of a calibration sensor coupled to observe a controlled flow parameter.

In the case of system fluids that undergo phase change such as refrigerants, or when the fluid undergoes extreme pressure, one uses simple spectrographic techniques such as white light sources, gratings and diode arrays to determine the state of the fluid medium. The state of fluid is gas, liquid or any combination of the two. Each state will present its own spectral response under constant measurement and observation. This is useful for determination of balance, or there lack of, in a refrigeration cycle where the refrigerant undergoes several phase changes.

Load Analysis: By performing detailed load calculations, solar radiation through windows and taking into account the R values of the building envelope, the present system provides a thermodynamic heat profile of the rooms as was illustrated in the above-cited patent application.

However, the present system goes further and uses spectroscopic spectral analysis for determining status or phases of flow inside mechanical systems such as refrigerant, compressed refrigerant and other fluid mediums. Moreover, the same spectral analysis reveals the carbon content, oxygen content, hydrogen and nitrogen contents or other elements within the HVAC pipes, ducts or refrigeration cycles. Spectral analysis is not confined to white light spectroscopy rather, one may use special spectroscopy involving X rays, ultra violet-visible-infra red, ultra sound, far infra red (FIR) laser spectroscopy and surface plasmons detectors for determining the status of mechanical system performance. For example, the ultra sound and surface plasmons will indicate leakages of fluid within the system.

The present system provides the spatial placements of the trend data for determining the flow parameters or flow variables for better control of the system.

Work flow of the present system includes:
(1) Obtain the AutoCAD Rivit (or any other CAD) files of the building.
(2) If the CAD files do not have the engineering drawings, then obtain those.
(3) Simulate the building in the virtual domain using software such as ANSYS or Fluent or that of the above cited patent application.

The result of the simulation is called Energy (Or Efficiency) Building Information Modeling (EBIM) which is different from traditional EEBIM that only simulates the structure and static environmental of a building, (i.e. using the software called Design Studios which is commercially available from AutoDesk). The present EEBIM models the ratings of the HVAC components, air flow, and other parameters as well as the component and air delivery system and their interaction with the heat load of the building. This constitutes a working model or EEBIM of the building.

### For a Building Being Designed

The largely conventional HVAC (in terms of components, delivery, etc.) is designed according to energy optimizations maximizing the system performance at the minimum energy cost. One designates the trend points on the components and zones of the system and observes the behavior of the system.

### To Retrofit an Existing Building

One models each existing component and constructs the performance EEBIM of the HVAC system. Then one commissions (tunes up) the building, then installs remote readout conventional sensors (temperature, pressure, velocity, LVDTs, and others) at critical points (trend points) on the components and zones of the system and start observing the trend data (system component performance vs. time) and issue commands for correcting the misbehaving parts. I.e., one finds out if the system is subcooling or superheating in the refrigeration cycle or how the zones are performing under normal load conditions.

Then using e.g., a cloud (software as a service) based control program, apply appropriate commands to correct for any deviation from the EEBIMs from the models.

### BacNET

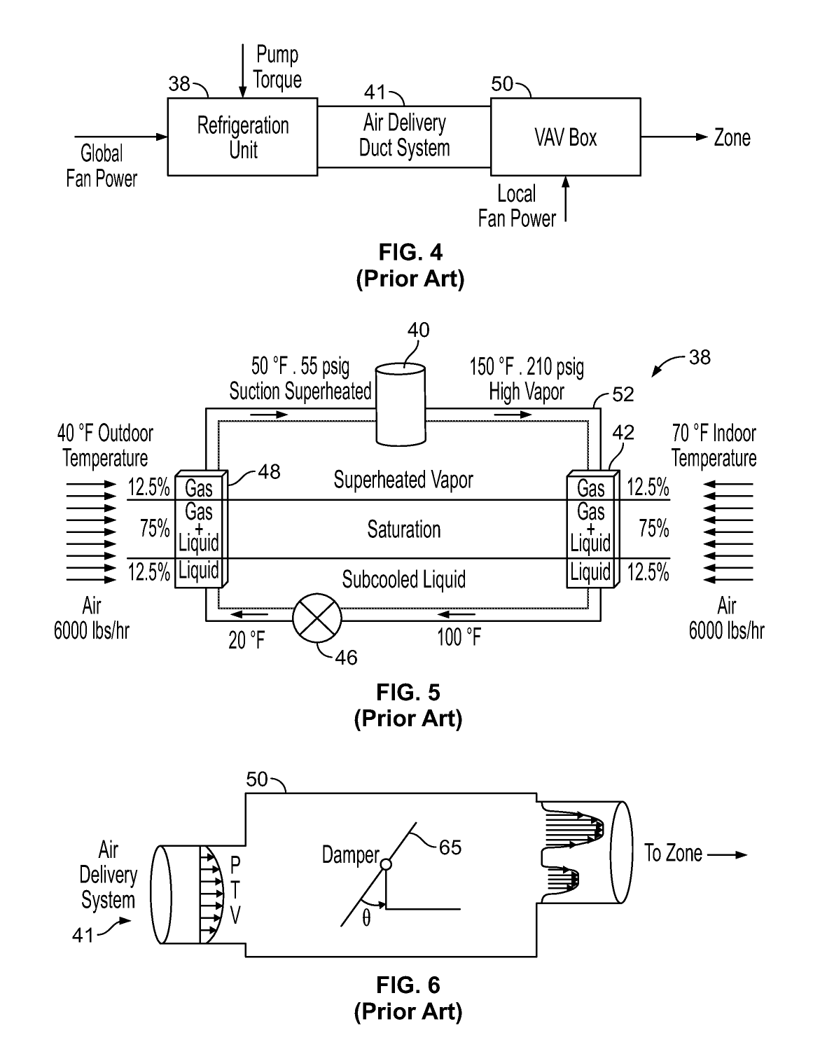

In both new and retrofit buildings, the present system monitor and control software communicates with the building's largely conventional mechanical systems through a communications network such as the conventional BacNET. BacNET is a standard that exists for building management systems. FIG. 4 illustrates such mechanical systems, including the refrigeration (cooling) unit 38 driven by fan power and a pump, air ducts 41, and VAV box 50 driven by a fan and outputting air to a building zone. Pump problems, valve problems and VAV box problems here along with the refrigeration cycle constitute 80% of the likely HVAC inefficiencies in one form or another.

Some aspects of energy management of the building includes configuring one or more mechanical systems by modifying them to prevent them from over performing. The performance of some mechanical systems may be more than an optimum value with respect to the performance of the overall system. Such modification results not only in reducing energy consumption, but also in prolonging the life expectancy of the modified system.

### Refrigeration Cycles

FIG. 5 illustrates graphically simple refrigeration cycle deficiencies. The actual problems in commercial buildings are more severe as the systems are much more complicated. The present system models and monitors the entire building plus its components to determine the optimum energy efficient system performance that is a function of the refrigeration cycle (and its components), indoor air, and outdoor air coming through the system.

These are the five main components (see FIG. 5) of a conventional cooling (refrigerating) system 38 used to generate cool air for a building: compressor 40, condenser 42, thermostatic expansion valve 46, evaporator 48, and piping 52 for coupling the above four components to carry the refrigerant. The piping determines the mass flow rate of the refrigerant in between the refrigeration cycles. Moreover, the associated air ducting 41 determines the delivery of the resulting cool air to the building as described in the above-referenced patent application.

The present system performs multi-phase CFD analysis, and determines the refrigerant mass throughput rate, temperature, velocity, pressure, its state (liquid, gas, and liquid-gas combination) and determines critical pressure and temperature, Transducer (sensor) measurements are used to monitor the refrigeration cycle.

For example for the above five component refrigeration unit, for a typical 3 ton capacity air conditioning unit 38 to work properly, one must model and determine optimum operation of: moving 9,000 pounds per hour of outdoor air through the condensing coil 42; maintain 32.5 degree F. average temperature difference across the condensing coil maintain refrigerant mass flow rate as a function of condensing and evaporative temperatures; maintain 30 degree F. average temperature across the evaporative coil 48; and move 6000 pound per hour of indoor air through the evaporator 48.

Saturation point or the boiling point of the refrigerant is important in that 75% saturation (mixture of liquid and gas) occurs inside the condenser 42 and evaporator 48. One should have 12.5% gas and 12.5% liquid to have a perfect cooling cycle. So it is important to measure saturation temperature directly at the middle of both the indoor and outdoor coils (evaporator and condenser). Also one needs to measure the temperature in between the components.

If the system does not maintain the above, then undesirably either superheating (upper part of FIG. 5) or subcooling (lower part of FIG. 5) occurs. SuperHeat is the temperature of refrigerant above saturation, when the refrigerant is in the vapor/gas state. One must have the proper amount of superheat to ensure no liquid reaches the compressor, and that the compressor does not overheat. As refrigerant goes through compressor, it absorbs the heat of compression and more winding heat added to superheated refrigerant. As the load conditions changes, then the superheat on fixed metering devices also changes. Superheat is used in fixed metering devices.

Subcooling (lower part of FIG. 4) is the temperature of refrigerant below saturation, when the refrigerant is in its liquid state. Refrigerant is subcooled in the condenser. As the outdoor air is pulled through the condensing coil, the refrigerant is cooled to the liquid state, so the refrigerant is cooled even more creating more subcooling through the condenser. Subcooling is needed to increase efficiency of the cycle. Measuring subcooling is done at the thermostatic expansion valve to make sure that valve is at a constant superheat if the valve is working properly.

### Problems of Incorrect Mass Flow Rate in the Refrigeration Cycle

“Floodback” is slogging of the compressor, and allowing liquid refrigerant to flow into the compressor, that results in damaging the compressor bearing over time by washing oil from compressor, damaged compressor valves, reducing efficiency and cooling capacity. Causes of floodback are low airflow such as less than 350 to 500 CFM, small returns (thus the duct sizes have to be increased), high static filters (to be replaced with lower static filters or increased grill area), low load conditions (low load temperatures), bypassed ducts in zoned systems (so the cure is to remove the bypass, as entering air has to be at 70 degrees F.).

Overcharge is little or no superheat refrigerant to the compressor, where too much liquid in the condenser causes his super cooling.

Undercharge is a high level of super heat refrigerant entering into the compressor, so little or no liquid causes subcooling.

### System Trending

A system trending example is provided in the above-referenced patent application, which simulated the entire building EEBIM including the duct systems and the geothermal cooling, radiant panels and chilled beam system. The pressure, temperature, humidity, and velocity and other flow parameters (i.e., mass flow rate, entropy, enthalpy, buoyancy, and the like) were determined and could be used a critical trend points for controlling the entire system.

### Center Fuse Pump and Transmission Valve Trending

The present system simulates operation of a center fusion pump in a cooling system, for data trending at its optimum energy efficiency operation point.

### Transmission Valve Trending

The system also simulates operation of the transmission valve 46, for data trending at its optimum energy efficiency operation point.

### VAV box Trending

Flow trending inside (at VAV boxes) and at the edge of the duct system is described in the above-referenced patent application and below.

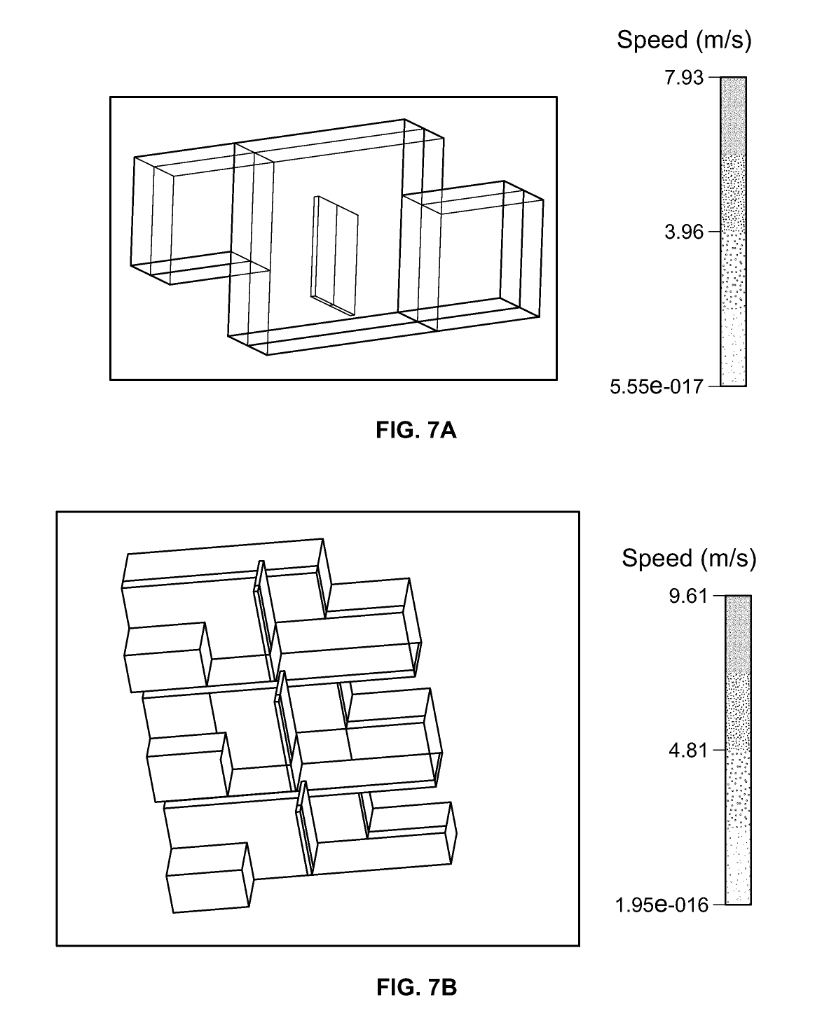

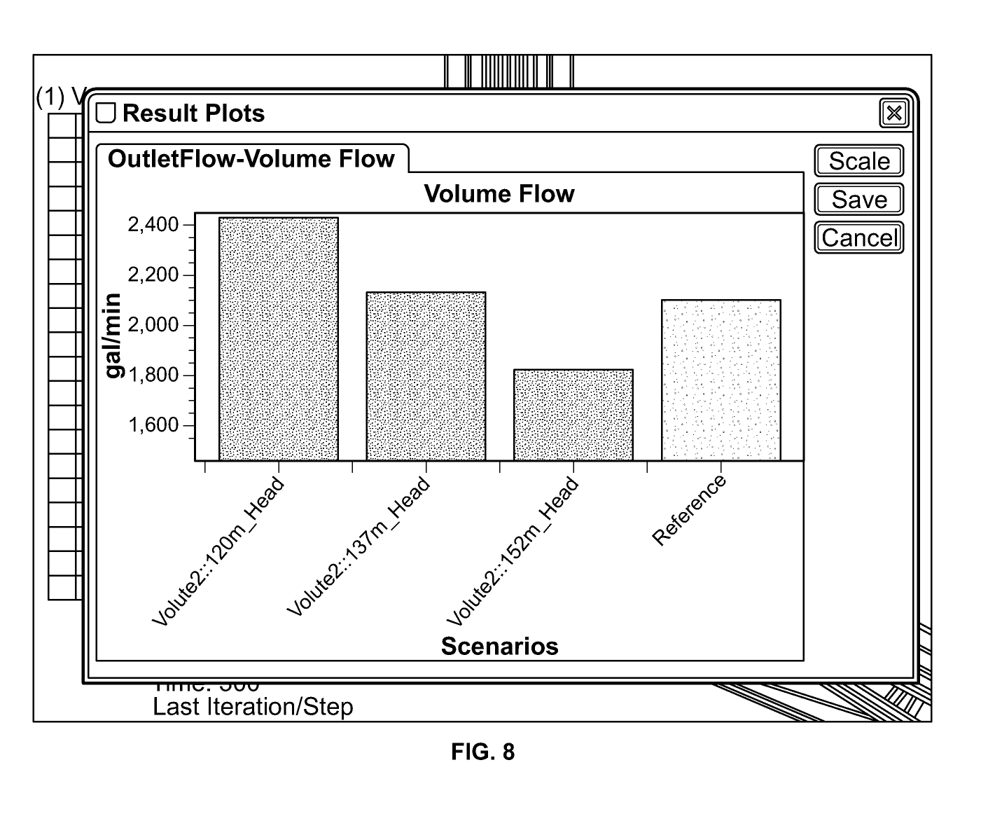

In a conventional VAV box, the air comes from the air delivery system to the VAV box, and then VAV box moves the air into the proper building cooling zone while controlling the flow with a damper. The present system simulates operation of a conventional VAV box in FIG. 6, in terms of air mass flow vs. velocity. The problem with traditional trending methods is that they monitor and control the electrical elements within the VAV box. However, the present system proposes an additional approach. The present system will model the air flow in and out of the VAV box 50 as shown in FIG. 6. The flow parameters as modeled in FIG. 7a include the input air temperature, velocity, pressure, damper positional angle and the size of the damper 65. This is important because the damper position angle 0 usually controls the air flow in a non-linear fashion. So depending on the position of the damper and the size of the damper 65, the output flow to the zone could have a non linear flow characteristic that will affect the temperature distribution within the zone and energy efficiency of the VAV operation.

Moreover, in large commercial buildings often having over 100 VAV boxes, the functioning (or lack of functioning) of one VAV box will affect the functioning of the neighboring VAV boxes, and thus the temperature of the neighboring zone. The present system establishes trend lines based on the flow parameters (temperature, pressure, velocity, angle position) as a function of time while observing them, e.g. every minute. The goal is to apply the most optimum energy efficient control by balancing the VAV box with respect to the zone and with respect to the neighboring VAV boxes while avoiding non-linear swings. See FIG. 7b showing a simulation of three neighboring VAV boxes, two opened and one closed. Therefore the present system not only produces optimum control, but also will prolong the life expectancy of the VAV boxes. The present system matrix control on one isolated VAV box and on a two neighboring VAV boxes is described below.

### Zone Trending

Zone trending is described in the above-referenced patent application, which shows the air velocity, temperature and throughput rate of the flow inside the rooms. The present system models the air flow produced by the mechanical components through the air delivery system and the duct systems, all the way through the zones and rooms while reducing the static pressure, non-linearity, and non laminar flows. The present system establishes the optimum flow, while modeling the room temperatures with respect to the system performance and the loads such as solar radiations through the windows, position and orientation of the rooms, number of occupants, and position of the furniture. Then the present system establishes accurate trend lines by placing relevant sensors for the entire system even through the duct systems and rooms while comparing them with the pre determined ideal models. This is an advantage of the present system over known systems that just place the sensors at random locations throughout the cooling zones and the rooms without determining what their optimum energy efficient behavior should be. The present system determines the flow parameters at every level and then compares the trend data with the ideal flow ones and issues control command accordingly.

### Present System Matrix

The system performance S of a building can be defined algebraically as:

S(x)=S1(x)*S2(x)*S3(x) . . . *Sn(x)

where x is the state space variable, or state variable representation of the flow variables such as pressure, temperature, velocity, mass flow rate, buoyancy, pressure drop, temperature gradient and enthalpy, and where operation * stands for convolution, or multiplication and integration of sub-systems as functions of x.

S(x) represents the total system performance, and is a convolved function of its subsystems designated as S1(x) through Sn(x). For example, S1 represents the main refrigeration subsystem, S2 represents the geothermal cooling system, S3 represents the radiant panels, S4 represents the chill beams, S5 represents the air delivery subsystem through the ducts, and S6 represents the zone subsystem.

Other mechanical systems such as boilers, solar hot water, and solar hybrid gas energy systems could constitute the other system components of the above equation.

The optimization criteria are, for example, a set of control commands such that the energy cost of the system and the pressure drops are minimized.

So in the present system expressed mathematically as a matrix, each variable that can be observed via trend lines is categorized as a space state variable or in short as a state variable, i.e., the zone temperatures, the air flow velocity in, etc. The present system models the interactive process of the flow by a flowing mathematical matrix or a characterization matrix, expressed algebraically as:

x(k+1)=A x(k)+B u(k)

y(k)=C x(k)+D u(k)

where variable k is the discrete time measured, e.g., in minutes (or seconds), for example k=0 is 12:00 AM, k=1 is 12:01 AM and k=1439 is 11:59 p.m. Variable x is the state variable (for example the air flow in the VAV box, or temperature in a zone, or pressure in the refrigerant cycle), and y is the output variable (for example, the temperature in a room).

Expressed as matrixes for each of coefficients A, B, C and D:

$$[ \begin{matrix}{P}_{( k + 1 )} \\ {T}_{( k + 1 )} \\ {V}_{( k + 1 )} \\ {m}_{( k + 1 )}\end{matrix} ] = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] [ \begin{matrix}{P}_{( k )} \\ {T}_{( k )} \\ {V}_{( k )} \\ {m}_{( k )}\end{matrix} ] + [ \begin{matrix}{b}_{1} & {b}_{2} & {b}_{3} & {b}_{4}\end{matrix} ] [ \begin{matrix}θ ( k ) \\ Global Fan Power \\ Local Fan Power \\ Pump Torque\end{matrix} ] \\ y ( k ) = [ \begin{matrix}{c}_{1} & {c}_{2} & {c}_{3} & {c}_{4}\end{matrix} ] [ \begin{matrix}{P}_{( k )} \\ {T}_{( k )} \\ {V}_{( k )} \\ {m}_{( k )}\end{matrix} ] + [ \begin{matrix}{d}_{1} & {d}_{2} & {d}_{3} & {d}_{4}\end{matrix} ] [ \begin{matrix}θ ( k ) \\ Global Fan Power \\ Local Fan Power \\ Pump Torque\end{matrix} ]$$

where P, T, m, and V are air pressure, temperature, mass flow rate and velocity respectively and presented as state variables. The VAV box damper angle, global and local fan powers and pump torque are the inputs of the system as shown above. Furthermore, one can calculate the enthalpy H of each part of the HVAC system using the following equation:

H=U+pV.

where
H is the enthalpy of the system,
U is the internal energy of the system,
p is the pressure at the boundary of the system and its environment and
V is the volume of the system.

Plots of the state variables are shown in FIGS. 3a, 3b, 3c, and 3d.

### Controlling for Non-linearities

If v(x)=f(x)+g(x), where f(x) is the linear terms and g(x) represents the non-linear terms, then it is prudent to bound the non-linear terms such that the behavior of v(x) is bounded:
v(x)=f (x)+Norm of {g(x)}, whereby function Norm applies some bound on g(x).

For example in a VAV box, the tilt angle of the damper (plus the size of damper) will introduce non-linearities in the air flow. So one bounds the cause of the non-linearity, namely the damper angle, by restricting it from going beyond certain angular positions that will otherwise dramatically create non-linear output velocity and pressure.

The present system establishes the system control based on the above system matrix as follows. For a simple two zoned building, with two VAV boxes, the temperature in each zone is a function of the air flow (determined by the air pressure, temperature, velocity, and damper tilt angle) in each VAV box.

Mechanical systems are inherently interactive. The air flow in a VAV box depends on velocity, temperature and pressure inside the VAV box. But the performance of one VAV box affects the neighboring VAV box. Similarly, the present system matrix allows the observation and control of both the HVAC and mechanical components on each other. The malfunctioning of a VAV box affects the other VAV boxes in the same zone.

For an exemplary building with 700 zones, and 1 different 20 different air handling units, the present system establishes the relevant parameters. So given the air delivery system parameters, then the present system defines the refrigeration cycle by defining the relevant parameters. There is interdependency between the refrigeration and cooling medium, and the air handling.

This description is illustrative and not limiting. Further modifications will be apparent to those skilled in the art in light of this disclosure, and are intended to fall within the scope of the appended claims.

We claim:

1. A system to monitor and control energy consumption of a structure, the system comprising:
a plurality of sensors, each positioned at a predetermined location in the structure, to measure a plurality of parameters relating to the energy consumption of the structure; and
a network configured to couple each sensor to a control unit and the control unit to a plurality of mechanical units within the structure;
wherein the control unit, in response to data received from the sensors, controls the plurality of mechanical units in combination to minimize total energy consumption of the structure.

2. The system claim 1, wherein each of the mechanical units comprises at least one of an air heating or cooling unit, water heater unit, energy storage unit, or renewable sources unit.

3. The system of claim 1, wherein the network includes at least one of wireless links, wired links, or power line links.

4. The system of claim 1, wherein the control unit further controls attributes of the mechanical units, including at least one of damper angles, fan speeds, pump torques, or fluids velocities, pressures, or temperatures.

5. The system of claim 1, wherein at least one of the sensors provides data for a spectral analysis.

6. The system of claim 1, wherein the control unit monitors parameters of the mechanical units as a function of at least one of time, fluid velocity, temperature, pressure, torque, humidity, buoyancy, mass flow rate, enthalpy, or enthropy.

7. The system of claim 1, wherein the control unit mathematically defines an overall performance of the mechanical units as a combination of individual performances of the mechanical units.

8. The system of claim 7, wherein the control unit determines for each time interval a set of parameters associated with each subunit as a function of the set of parameters for a previous time period, a set of predetermined coefficients, and a set of input power levels.

9. The system of claim 1, wherein the control unit includes a plurality of control subunits in communication with one another.

10. A method to monitor and control energy consumption of a structure, the method comprising the acts of:
providing a plurality of sensors, each positioned at a predetermined location in the structure, to measure a plurality of parameters relating to the energy consumption of the structure;
coupling, via a network, each sensor to a control unit and the control unit to a plurality of mechanical units within the structure; and
controlling, via the control unit, in response to measured data received from the sensors, the plurality of mechanical units in combination to minimize total energy consumption of the structure.

11. The method of claim 10, further comprising improving an overall efficiency of the structure by coordinating subcomponents of the overall efficiency including at least one of a source, component, storage, monitoring and control, or distribution efficiencies.

12. The method of claim 10, further comprising:
determining, using Computational Fluid Dynamic (CFD) methods, flow variables associated with each mechanical units; and
establishing critical trend lines, using the flow variables, to be used in control and monitoring of the mechanical units.

13. The method of claim 12, wherein determining the flow variables include determining desirable flow conditions and wherein the flow variables include variables of at least one of a linear flow, a multiphase flow, a compressive flow, a laminar flow, a turbulent flow or, a non linear flow.

14. The method of claim 12, further comprising establishing a control matrix of the structure using the flow variables as state variables of the control matrix.

15. The method of claim 12, wherein the state variables are related to at least one of local or global control commands.

16. The method of claim 11, further comprising identifying, at predetermined time intervals, a source of energy that is most cost effective.

17. The method of claim 12, further comprising benchmarking energy consumption of the structure and various energy flow sources and components.

18. The method of claim 12, further comprising identifying one or more trend lines that are indicative of a malfunction.

19. The method of claim 10, wherein minimizing the total energy consumption of the structure includes at least one of reducing global fan power, refrigeration cycle energy usage, local fan power, static pressures, non-linearties, interdependencies, or turbulences, or increasing outside air or natural air ventilations by using at least one of fuzzy logic, neural network, stochastic processing, or binary logic for decision making.

20. An apparatus to monitor and control energy consumption of a structure, the structure having a plurality of sensors positioned at predetermined locations within the structure to measure a plurality of parameters relating to energy consumption of the structure, the apparatus comprising:
a port adapted to couple, via a network, to the plurality of sensors and the plurality of mechanical units within the structure;
a processor coupled to the port;
wherein the processor, in response to measured data received from the sensors, transmits signals via the second port to the plurality of mechanical units to control the mechanical units to minimize total energy consumption of the structure.

21. A system for configuring a plurality of mechanical units within a structure to minimize energy consumption of the mechanical units, the system comprising:
a memory configured to store data provided by a plurality of sensors, each sensor positioned at a predetermined location within the structure to measure a plurality of parameters relating to the energy consumption of the structure;
a processor coupled to the memory;
wherein the processor, using to the data stored in the memory, determines a configuration of the plurality of mechanical units in combination to minimize total energy consumption of the mechanical units; and
the memory being adapted to store the configuration of the mechanical units.

22. The system of claim 21, wherein the sensors include at least one of temperature, pressure, humidity, flow rate, gas concentration, fluid state, buoyancy, surface plasma, acoustic, magneto-electric, magneto-optic, or pneumatic sensors.

23. The system of claim 21, wherein the mechanical units include at least one of a boiler unit, a refrigeration cycle unit, a geothermal unit, a renewable energy unit, an air handling unit, an energy storage unit, an air handling unit, or a variable air volume (VAV) unit.

24. The system of claim 21, wherein configuring the plurality of the mechanical systems results in extending a life time of at least of the plurality of mechanical systems.

25. The system of claim 21, wherein configuring the plurality of mechanical systems includes modifying at least one of the plurality of mechanical systems to prevent it from over performing.

26. A processor-based method for designing and simulation of a heating and ventilation environment partitioned into a plurality of units, the method comprising:
storing information relating to the heating and ventilation environment in memory;
storing an initial design and a plurality of boundary conditions for the heating and ventilation environment and the plurality of units in the memory;
for each unit of the plurality of units, determining an associated heat load and an associated volume;
determining a set of initial conditions by modeling the heating and ventilation environment as an electrical circuit using circuit elements to model the associated heat loads and the associated volumes of the plurality of units;
using a processor-based numerical method, determining solutions of a set of differential equations associated with the heating and ventilation environment, based on the boundary conditions and the determined initial conditions; and
using the solutions, modifying the stored initial design.

27. The processor-based method of claim 26, wherein the plurality of units include at least one of:
at least one building zones including at least one room,
one or more fluid channels, or
one or more mechanical systems.

28. The processor-based method of claim 26, wherein the associated heat load and the associated volumes are modeled as respective resistors and capacitors.

29. The processor-based method of claim 26, wherein the initial conditions are related to fluid flows and temperatures associated with the plurality of units.

30. The processor-based method of claim 26, wherein modifying the stored initial design comprises reducing an energy consumption of the heating and ventilation environment to a lowest value.

31. The processor-based method of claim 26, wherein reducing the energy consumption of the heating and ventilation environment includes reducing energy consumptions due to circulation of a working fluid, and at least one of heating or cooling of the working fluid.

32. The processor-based method of claim 26, further comprising modeling the heating and ventilation environment with a plurality of electrical circuits coupled in at least one of series or parallel topology.

33. The processor-based method of claim 26, wherein the circuit elements used to model the heat load and the volume comprise an electrical resistor and an electrical capacitor, respectively.

34. The processor-based method of claim 26, further comprising modeling the air flow and energy consumption as electrical current and electrical power consumption, respectively.

35. The processor-based method of claim 27, wherein the plurality of boundary conditions for the at least one building zone are determined based on at least one of outside temperature, windows locations, walls insulations, roofs insulations, solar radiation, and windows insulations.

36. The processor-based method of claim 27, wherein the plurality of boundary conditions for the mechanical system is determined based on a minimum air flow and an interior temperature.

37. The processor-based method of claim 26, wherein the plurality of boundary conditions is provided in a predetermined computer aided design (CAD) format.

38. The processor-based method of claim 26, wherein in the modified design, flow of a working fluid into the plurality of units are controlled separately to allow differing flows in each unit.

39. The processor-based method of claim 38, further comprising providing a detailed design for the heating and ventilation environment by applying the modified design to a CAD tool using computational fluid dynamics (CFD) algorithms to attain a solution.

40. The processor-based method of claim 39, wherein comprising providing the detailed design includes performing a sensitivity analysis using at least one of a flow or a temperature of the working flow.

41. The processor-based method of claim 40, further comprising:
using results of the sensitivity analysis modifying the detailed design; and
applying the modified detailed design to the CAD tool to attain a modified solution.

42. A machine-readable-medium storing instructions, which when executed by one or more processors perform a method for designing and simulation of a heating and ventilation environment partitioned into a plurality of units, the method comprising:
storing information relating to the heating and ventilation environment in memory;
storing an initial design and a plurality of boundary conditions for the heating and ventilation environment and the plurality of units in the memory;
for each unit of the plurality of units, determining an associated heat load and an associated volume;
determining a set of initial conditions by modeling the heating and ventilation environment as an electrical circuit using circuit elements to model the associated heat loads and the associated volumes of the plurality of units;
using a processor-based numerical method, determining solutions of a set of differential equations associated with the heating and ventilation environment, based on the boundary conditions and the determined initial conditions; and
using the solutions, modifying the stored initial design.

43. An apparatus for designing and simulation of a heating and ventilation environment partitioned into a plurality of units, the apparatus comprising:
memory to store:
information relating to the heating and ventilation environment, and
an initial design and a plurality of boundary conditions for the heating and ventilation environment and the plurality of units;
a processor to:
determine, for each unit of the plurality of units, an associated heat load and an associated volume;
determine a set of initial conditions by modeling the heating and ventilation environment as an electrical circuit using circuit elements to model the associated heat loads and the associated volumes of the plurality of units;
execute a numerical method to determine solutions of a set of differential equations associated with the heating and ventilation environment, based on the boundary conditions and the determined initial conditions; and
modify the stored initial design, using the solutions.
